(19) United States
(12) Patent Application Publication
(10) Pub. No.: US 2002/0038942 A1
(43) Pub. Date: Apr. 4, 2002

(54) Expandable pediatric walker

(76) Inventors: Paul Gilles, Amherst, OH (US); Jason Gustwiller, Hilliard, OH (US)

Correspondence Address: Laura F. Shunk, Hudak & Shunk Co., L.P.A., Suite 808, 7 West Bowery Street, Akron, OH, 44308, US

(21) Appl. No.: 09/911,560

(22) Filed: Jul. 24, 2001

Related U.S. Application Data
(60) Provisional application No. 60/236,488, filed on Sep. 29, 2000.

(51) Int. Cl. B62B 7/00

(52) U.S. Cl. 280/87.051; 280/639

(57) ABSTRACT

An expandable pediatric walker is provided which has two U-shaped frames which are pivotally connected so as to scissor, and a link is provided between the crossbars of the respective U-shaped frames to define the height of the handgrips supported on the frames, and to allow the walker to be collapsed.

### This patent application is based upon U.S. Provisional Application Serial No. 60/236,488, filed Sep. 29, 2000

The invention relates to the field of ambulatory supports more commonly known as “walkers”, and more particularly relates to a foldable pediatric walker which can be expanded to compensate for growth.

### BACKGROUND OF THE INVENTION

Certain childhood conditions and trauma result in decreased ability to balance on two feet and accordingly to walk or run. Likewise, there are conditions which hinder the ability to use the lower trunk and/or limbs. Attention has been focused on meeting the health care needs of children who are subject to these conditions, such as by providing pediatric wheelchairs and walkers. These devices need to meet the traditional requirements of providing safe, convenient, and costeffective support. In addition, it is desirable that they expand in order to accommodate the child user as they grow. Convenience contemplates that the device be easily folded and unfolded without requiring additional help. Safety dictates that the device can be unidirectional, in order to prevent it from being pushed in the wrong direction, and further that the device bear the required load during use.

### SUMMARY OF THE INVENTION

The present invention has a foldable frame comprising two U-shaped members which are hinged relative to each other so that the cross members of the U-frames are parallel. An expandable link is pivotally attached at either end to these cross members. The link can be locked at a desired length to define the relative height of the handgrips of the walker. The laterally spaced handgrips are supported in the upwardly extending side legs of the upwardly opening U-shaped member. In a further embodiment, the handgrips are supported in a telescoping relationship to the tubular rear wheel legs which are parallel and adjacent to the side legs of the upwardly extending frame. The other U-frame has side legs which extend away from the plane defined by the two cross members. The side legs are angled downwardly in the open position from the rear cross member, and are supported on front wheels or a pivot caster. Either set of wheels may include a braking mechanism and/or a unidirectional function. Optionally, the side legs of the downwardly facing U-frame can be expandable, such as provided by a telescoping relationship. The two intersecting frames define a space for the user to reside during use, generally facing toward the open side of the support. Thus, this walker has a posterior support frame which provides the general support for the opposing, laterally spaced handgrips which the child user holds during ambulation.

### OBJECT OF THE INVENTION

It is an object of the invention among other things, to independently and/or collectively provide a walker which has an expandable frame to accommodate growth, which can be used as a posterior walker, and which is easily foldable to allow for non-use.

### BRIEF DESCRIPTION OF THE DRAWINGS

FIG. 1 is top perspective view of a first embodiment of the invention;

FIG. 2 is a top perspective view of a second embodiment of the invention in a contracted condition;

FIG. 3 is a top perspective view of the second embodiment of the invention which is shown in FIG. 2 in an expanded condition; and

FIG. 4 is an exploded assembly drawing from the same view as is shown in FIG. 3.

### DETAILED DESCRIPTION OF THE INVENTION

As shown in FIG. 1, the rolling ambulatory support or “walker” of the present invention has a foldable frame 10 generally comprising a first U-shaped member 12, and a second U-shaped member 14. The first and second U-shaped members each comprise a cross bar 16, 18, which is transverse to and connects two parallel side legs 20, 22. When the walker is opened for use, the first U-frame opens upwardly, and the second U-shaped frame opens so that the side legs 22 are angle downwardly. However, both U-shaped frame members are open in the same direction so as to define an open space for the user. The U-shaped frame members are hinged relative to each other on each of the respective side legs 20, 22 so that the cross members 16, 18 of the U-frames are parallel. An expandable link 25 is pivotally attached at either end to these cross members. The link 25 can be locked at a desired length to define the relative height of the handgrips 27 of the walker which are supported by the upwardly opening U-shaped frame member. The height of the handgrips is defined by the length of the link 25, and the relative angle of the side legs 20 to the ground. Further, the side legs are supported by adjacent, parallel legs 30 which each have a wheel 32.

The other U-frame 14 has side legs 22 which extend away from the plane defined by the two cross members. These side legs 22 are angled downwardly in the open position from the rear cross member 18, and are supported on front wheels 34. Either set of wheels may include a braking mechanism and/or a unidirectional finction. Optionally, the side legs of the downwardly facing U-frame can be expandable, such as provided by a telescoping relationship. The two intersecting frames define a space 40 for the user to reside during use, generally facing toward the open side of the support. Thus, this walker has a posterior support frame which provides the general support for the opposing, laterally spaced handgrips which the child user holds during ambulation.

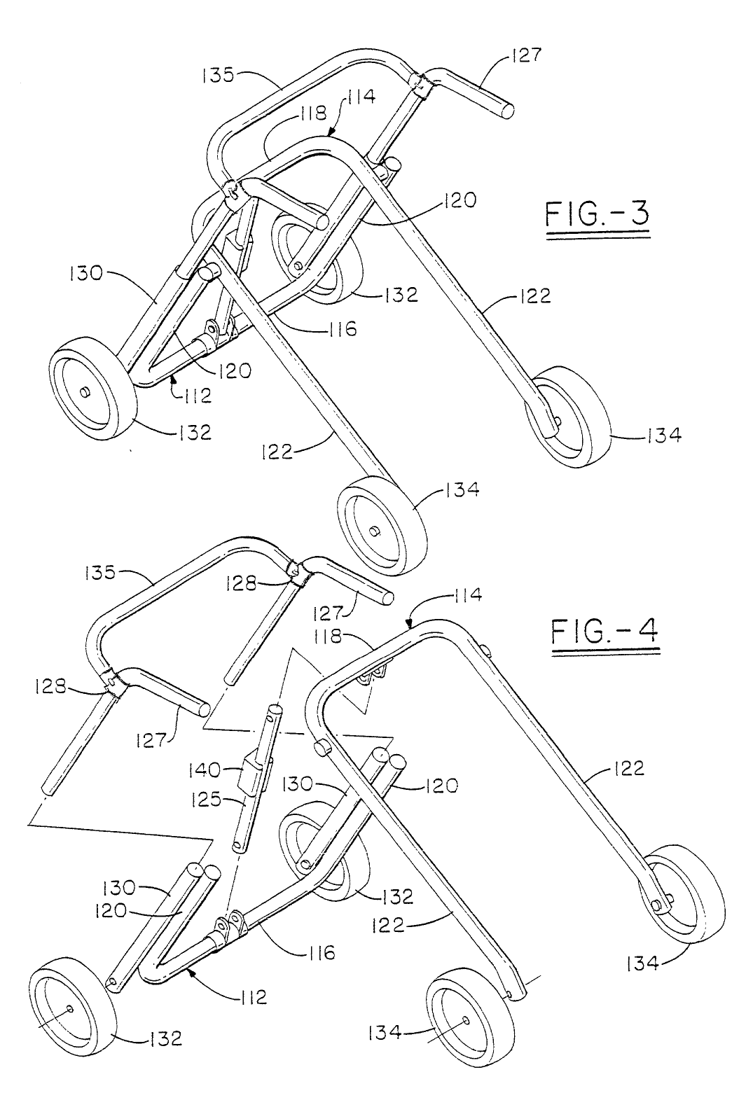

The second embodiment of the invention also includes intersecting pivoting first and second U-shaped frames, 112, 114. The downward facing U-shaped frame has a cross bar 118, which transversely joins two downwardly angled side legs 122 that are carried on front wheels 134. The upwardly facing U-shaped frame member 112 has a cross bar 116 which likewise joins two side legs 120. Once again, the wheel legs 130 are longitudinally co-linear with the side legs 120. These legs 130 carry the rear wheels 132. In this embodiment, the handgrips 127 are releasably supported in a telescoping relationship to the tubular rear wheel legs. An additional link 135 connects the two telescoping handgrips 127. The handgrips 127 are rotatably held in collars 128 which allow them to be rotated inward for storage and shipping purposes, and ease of adjustment. Further, the handgrips can be locked in the open position for use. A link member 125 is pivotally connected at either end to the cross bars 116, 118 of the U-shaped frames, and defines the distance between them. A pop lock 140 has a spring-loaded détente which snaps a button into one of a series of holes to lock the link (not shown) into a desired length. The pop lock allows a convenient way to collapse the walker by using a single hand to unlock the walker by holding the button inward. FIG. 3 illustrates the walker in an expanded position.

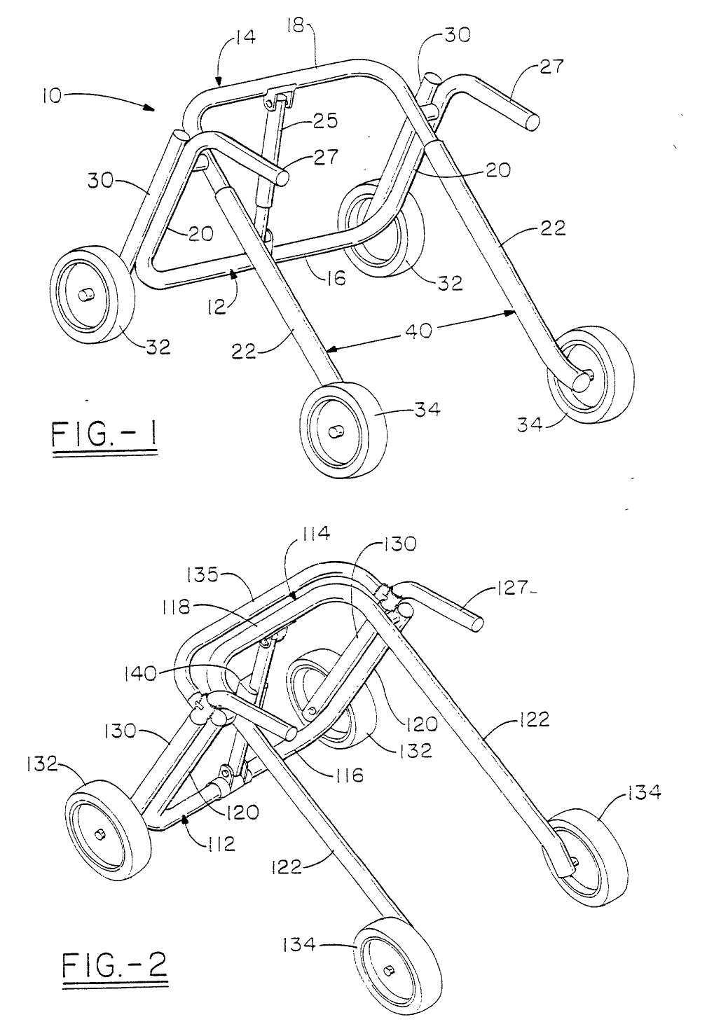

FIG. 4 shows an exploded assembly view of the invention shown in FIGS. 2 and 3. This provides an illustration of the components of the invention.

In use, a child will stand with his back to the frame of the walker, resting his hands on the handgrips and walking toward the open side of the walker assembly. One set of wheels, typically the back set are unidirectional so that the child may roll the walker behind him using the device to balance during ambulation.

While in accordance with the patent statutes the best mode and preferred embodiment have been set forth, the scope of the invention is not limited thereto, but rather by the scope of the attached claims.

What is claimed is:

1. A walker comprising a first U-shaped frame having a cross member which transversely joins laterally opposing side members, and a second U-shaped frame which has a cross member which transversely joins laterally opposing side members, wherein the respective side legs of each of the frame members are joined in a pivoting relationship each to the other, and an expandable link joins the cross member of the first U-shaped frame to the cross member of the second U-shaped frame.

2. A walker as set forth in claim 1, wherein the walker further has two pairs of wheels.

3. A walker as set forth in claim 1, wherein first U-shaped frame is open upward and the second U-shaped frame is open downward, and a pair of handgrips are cooperatively joined to the side legs of the first U-shaped frame.

4. A walker as set forth in claim 1, wherein the expandable link can be locked in an extended position and can be unlocked to allow the walker to be collapsed.

5. A walker as set forth in claim 4, wherein the link can be unlocked using a single hand.

6. A walker as set forth in claim 5, wherein the link is locked using a pop lock.

7. A walker as set forth in claim 3, wherein the handgrips can be pivoted inward relative to the side legs of the first U-shaped frame.

8. A walker as set forth in claim 2, wherein one set of wheels only roll in one direction.

9. A walker as set forth in claim 8, wherein the first U-shaped frame opens upward and the second U-shaped frame is open downward and a pair of one-way wheels are joined to the first U-shaped member.

10. A walker as set forth in claim 2, wherein at least one pair of wheels includes a brake mechanism.

11. A walker comprising:
a first U-shaped frame having a cross member which transversely joins laterally opposing side members, and
a second U-shaped frame which has a cross member which transversely joins laterally opposing side members, wherein the respective side legs of each of the frame members are joined in a pivoting relationship each to the other, and
an expandable link joins the cross member of the first U-shaped frame to the cross member of the second U-shaped frame, and
wherein the walker further has two pairs of wheels, and
wherein first U-shaped frame is open upward and the second U-shaped frame is open downward, and a pair of handgrips are cooperatively joined to the side legs of the first U-shaped frame.

12. A walker as set forth in claim 11, wherein the expandable link can be locked in an extended position and can be unlocked to allow the walker to be collapsed.

13. A walker as set forth in claim 12, wherein the link can be unlocked using a single hand.

14. A walker as set forth in claim 13, wherein the link is locked using a pop lock.

15. A walker as set forth in claim 14, wherein the handgrips can be pivoted inward relative to the side legs of the first U-shaped frame.

16. A walker as set forth in claim 15, wherein one set of wheels only roll in one direction.

17. A walker as set forth in claim 16, wherein the first U-shaped frame opens upward and the second U-shaped frame is open downward and a pair of one way-wheels are joined to the first U-shaped member.

18. A walker as set forth in claim 11 wherein at least one pair of wheels can freewheel.

19. A walker as set forth in claim 11 wherein at least one pair of wheels comprise a pair of swivel casters.
